(19) United States
(12) Patent Application Publication
(10) Pub. No.: US 2026/0326732 A1
(43) Pub. Date: Oct. 22, 2026

(54) ELECTROPNEUMATIC BRAKE SYSTEM FOR A VEHICLE, METHOD, COMPUTER PROGRAM AND/OR COMPUTER-READABLE MEDIUM, CONTROL UNIT, VEHICLE

(71) Applicant: ZF CV Systems Europe BV, Brussels (BE)

(72) Inventors: Julian Van Thiel, Grossburgwedel (DE); Janik Ricke, Uetze-Eltze (DE); Thomas Dieckmann, Pattensen (DE); Karl-Heinz Riediger-Janisch, Hannover (DE); Robert Otremba, Ronnenberg (DE)

(21) Appl. No.: 19/689,083

(22) Filed: May 27, 2026

Related U.S. Application Data
(63) Continuation of application No. PCT/EP2024/082344, filed on Nov. 14, 2024.

(30) Foreign Application Priority Data
Nov. 27, 2023 (DE) 10 2023 133 083.7

(51) Int. Cl. B60T 13/66; B60T 13/26

(52) U.S. Cl. CPC B60T 13/662; B60T 13/26

(57) ABSTRACT

An electropneumatic brake system is for a vehicle, in particular a commercial vehicle. The electropneumatic brake system has a parking brake system and a service brake system. The electropneumatic brake system further includes a controllable vent valve arrangement and a venting path for pneumatically connecting the parking brake system to the service brake system. The vent valve arrangement is configured to control venting of the parking brake system via the venting path and via the service brake system.

### CROSS-REFERENCE TO RELATED APPLICATIONS

This application is a continuation application of international patent application PCT/EP2024/082344, filed Nov. 14, 2024, designating the United States and claiming priority from German application 10 2023 133 083.7, filed Nov. 27, 2023, and the entire content of both applications is incorporated herein by reference.

### TECHNICAL FIELD

The disclosure relates to an electropneumatic brake system for a vehicle, in particular a commercial vehicle, wherein the electropneumatic brake system includes a parking brake system and a service brake system. The disclosure also relates to a method for operating an electropneumatic brake system, to a computer program and/or computer-readable medium, to a control unit for an electropneumatic brake system, and to a vehicle, in particular a commercial vehicle, including a control unit and/or an electropneumatic brake system.

### BACKGROUND

For modern vehicles, reducing noise emissions is becoming increasingly important with the increasing electrification of drive systems, in particular for vehicles that are partially and/or exclusively electrically powered.

One source of noise can be a pneumatic system, in particular an electropneumatic brake system. Such systems include a compressed air supply and/or a compressor that can apply air pressure to an inlet valve. The inlet valve is connected to the working volume of a pneumatic actuator, which releases a flow of air through an outlet valve during and/or after actuation. Noise can be generated in particular when air is released or vented through the outlet valve. It is possible to throttle the release. However, throttling the release can have an influence on the actuation of the actuator.

For example, an electropneumatic parking brake system can emit comparatively loud noises when a parking brake function is activated, that is, when the parking brake is applied.

Patent application DE 10 2023 104 841 describes a valve arrangement for a pneumatic system of a vehicle, in particular a utility vehicle, including: an outlet valve arrangement for venting the pneumatic system, a control unit for operating the valve arrangement for aerating and venting a pneumatic actuator, wherein the control unit is configured to output a switching signal for switching the outlet valve arrangement to the outlet valve arrangement, and the outlet valve arrangement can be switched to a noise-reducing first venting mode or a rapid-venting second venting mode on the basis of the switching signal.

### SUMMARY

It is an object of the disclosure to reduce noise emission of an electropneumatic brake system. Various embodiments achieve the object of reducing the noise emission of an electropneumatic brake system with a parking brake system when the parking brake system is actuated,

The object is achieved by various embodiments of the disclosure.

According to an aspect of the disclosure, an electropneumatic brake system is provided for a vehicle, in particular a commercial vehicle, wherein the electropneumatic brake system has a parking brake system and a service brake system; the electropneumatic brake system has a controllable vent valve arrangement and a venting path for pneumatically connecting the parking brake system to the service brake system; and the vent valve arrangement is configured to control the venting of the parking brake system via the venting path and via the service brake system.

It has been recognized that noise reduction can be achieved when the parking brake system is vented via the service brake system. For this purpose, the electropneumatic brake system has the venting path, which can vent the parking brake system via the service brake system,

This allows the parking brake system to be vented completely or partially via the service brake system, or compressed air from the parking brake system to be transferred to the service brake system. This means that little or no air is released into the environment, thus avoiding or reducing the associated noise emissions.

Depending on the initial situation in the service brake system, compressed air can initially be released from the parking brake system into the environment with little or no direct venting. In addition, the compressed air transferred from the parking brake system to the service brake system ensures that the vehicle is held safely at a standstill during a transition phase when the parking brake is applied.

Optionally, the vent valve arrangement is configured to vent the parking brake system in two steps. It has been recognized that transferring the compressed air from the parking brake system to the service brake system as the first of the two steps requires a time that can be characterized by the pressure and/or volume flow. Once the transfer of compressed air is at least partially complete, the compressed air now distributed between the two systems can be released in a second step of the two steps with significantly less noise.

Optionally, the vent valve arrangement is configured to control the venting of the parking brake system in a first step via the service brake system and in a second step via a discharge path of the parking brake system that is different from the venting path. The discharge path is configured to release compressed air from the parking brake system directly and/or via noise attenuation into the environment, that is, without the compressed air being transferred to the service brake system. After partial transfer, the compressed air can be vented into the environment both via the venting and optionally noise attenuation of the service brake system and via the discharge path and optionally noise attenuation of the parking brake system in order to discharge the air at a reduced pressure and/or volume flow and thus with reduced noise.

Optionally, the vent valve arrangement has a quick release valve. For this purpose, a rear axle modulator and/or an actuator may in particular have the quick release valve (QRV) or quick vent valve or one or more quick release valves. The quick release valve or valves enable effective and selective connection of the parking brake system to the service brake system via the venting path.

Optionally, the vent valve arrangement has a 3/2-way valve that can be controlled by the parking brake system. The 3/2-way valve is configured to control the venting of the parking brake system via the venting path. The 3/2-way valve can be used to control the vent valve arrangement.

Optionally, the parking brake system has a spring accumulator and a vent connection; the service brake system has a service brake connection; and the vent valve arrangement has a solenoid valve connected between the vent connection and the service brake connection. The solenoid valve is configured to control the venting of the parking brake system via the venting path. This makes it possible to selectively establish a connection between the vent port and the service brake port for a first step in venting the parking brake system,

Optionally, the electropneumatic brake system has a silencer device, and the parking brake system and/or the service brake system are configured to vent via the silencer device. This makes it possible to further reduce the emission of noise caused by venting via the silencer device when the compressed air is released into the environment.

According to an aspect of the disclosure, a method for operating the above-described electropneumatic brake system is provided, wherein the method includes: detecting an actuation signal for actuating the parking brake system; determining a control signal for controlling the vent valve arrangement based on the actuation signal; and outputting the control signal. Optionally, the method includes one or more of the optional and/or advantageous features described above with reference to the brake system in order to achieve an associated technical effect.

According to an aspect of the disclosure, a computer program and/or a computer-readable medium is provided. The computer program and/or the computer-readable medium includes/include commands which, when the program or the commands is or are executed by a control unit, cause the latter to carry out the method according to the disclosure and/or steps of the method. The computer program and/or the computer-readable medium optionally include(s) commands which, when the program or the commands is or are executed by a control unit, cause the latter to carry out the method steps described as being advantageous or optional, in order to obtain a technical effect associated therewith.

According to an aspect of the disclosure, a control unit is provided for the above-described electropneumatic brake system, wherein the control unit is configured to carry out the above-described method. Optionally, the control unit is configured to implement one or more of the features described as optional and/or advantageous with reference to the brake system and/or the method in order to achieve a technical effect associated therewith.

According to an aspect of the disclosure, a vehicle, in particular a utility vehicle, is provided including the control unit and/or the electropneumatic brake system described above. Optionally, the vehicle, in particular utility vehicle, is configured to implement one or more of the features described as optional and/or advantageous with reference to the brake system, the method and/or the control unit in order to achieve a technical effect associated therewith.

### BRIEF DESCRIPTION OF DRAWINGS

The invention will now be described with reference to the drawings wherein:

FIG. 1 shows a schematic illustration of a vehicle, in particular a commercial vehicle, according to an aspect of the disclosure;

FIG. 2 shows a schematic illustration of an electropneumatic brake system according to an aspect of the disclosure,

FIG. 3 shows a schematic illustration of a vehicle, in particular a commercial vehicle, according to an aspect of the disclosure;

FIG. 4 shows a schematic illustration of a flow chart of a method according to an aspect of the disclosure; and,

FIG. 5 shows a schematic illustration of a computer-readable medium according to an aspect of the disclosure.

### DETAILED DESCRIPTION

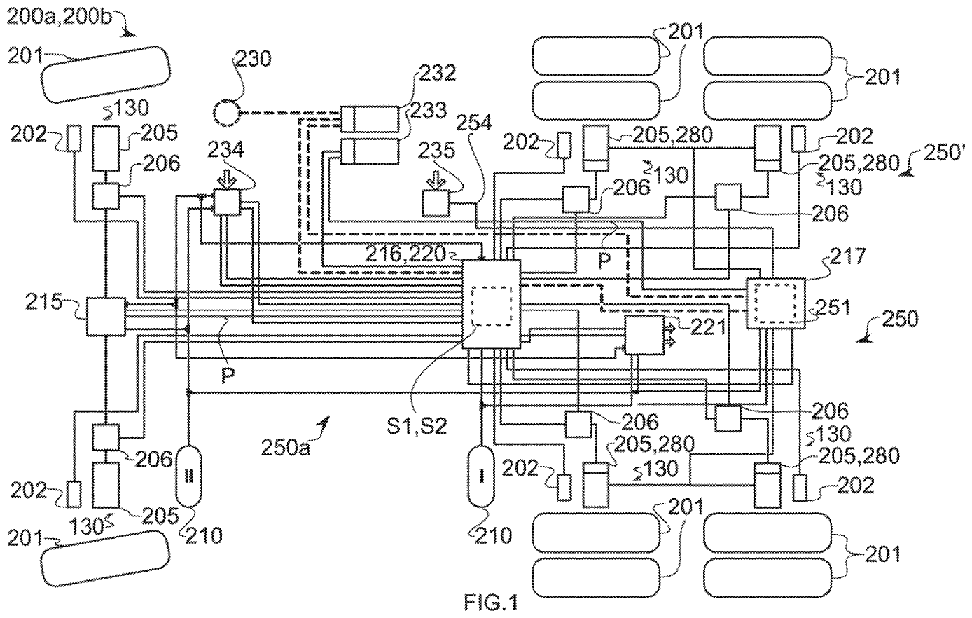

FIG. 1 shows a schematic illustration of a vehicle 200a, in particular a utility vehicle 200b, according to an aspect of the disclosure, The vehicle 200a, in particular utility vehicle 200b, is referred to below as vehicle 200a, 200b. The vehicle 200a, 200b is a land vehicle, in particular a towing vehicle of a multi-unit vehicle 200a, 200b. In another embodiment, the vehicle 200a, 200b may be a single-unit vehicle 200a, 200b and/or a trailer vehicle (not shown).

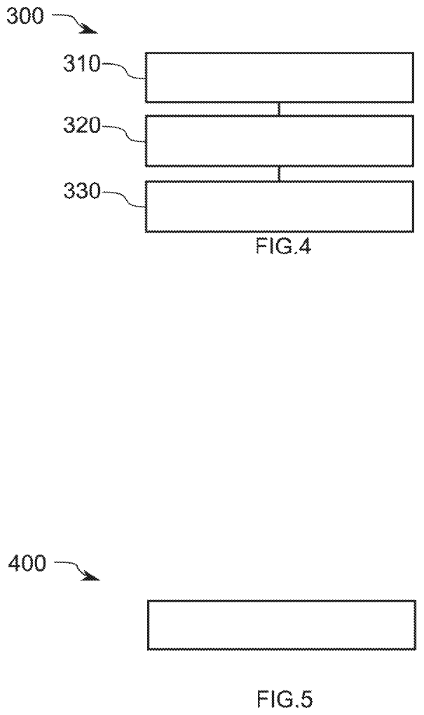

The vehicle 200a, 200b according to FIG. 1 is configured to carry out the method 300 described with reference to FIG. 4. To this end, the vehicle 200a, 200b according to FIG. 1 has an electropneumatic brake system 250′ with a control unit 220.

The electropneumatic brake system 250′ has a parking brake system 250 and a service brake system 250a. The parking brake system 250 is configured to engage a parking brake, that is, to activate a parking brake function 251, and to release the parking brake, that is, to deactivate a parking brake function 251. The service brake system 250a is configured to apply a braking torque to one or more wheels 201 of the vehicle 200a, 200b in order to decelerate the vehicle 200a, 200b.

The vehicle 200a, 200b has a brake transducer 234. The brake transducer 234 may, for example, include a brake pedal with a valve substructure to convert a driver-side brake request into a signal for operating the electropneumatic service brake system 250a and/or to convert a brake request mediated by an automated driving function 230 into a signal for operating the electropneumatic service brake system 250a. The brake transducer 234 is connected to the control unit 220 for communication purposes in order to transmit the brake request to the control unit 220.

The vehicle 200a, 200b has a front axle modulator 215. The front axle modulator 215 (FAM) is configured to operate components of the electropneumatic service brake system 250a relating to a front axle of the vehicle 200a, 200b. The front axle modulator 215 is connected to the brake transducer 234 and to the control unit 220 for communication purposes in order to receive a signal corresponding to the brake request for braking.

The vehicle 200a, 200b has a rear axle modulator 216 (RAM) and a parking brake module 217, wherein the control unit 220 is configured as the rear axle modulator 216. The rear axle modulator 216 is configured to operate components of the service brake system 250a relating to the rear axles of the vehicle 200a, 200b. The parking brake module 217 is configured to operate the electropneumatic parking brake system 250. The parking brake module 217 is connected to the brake transducer 234 via the control unit 220 in order to receive a signal corresponding to the brake request for actuating the service brake system 250a.

The parking brake module 217 is configured to control the parking brake function 251 of the parking brake system 250. In particular, the parking brake module 217 is configured to activate the parking brake function 251 of the parking brake system or to apply a parking brake. The parking brake function 251 causes the vehicle 200a, 200b to be held stationary.

The front axle modulator 215 and the parking brake module 217 are connected to the control unit 220 and the rear axle modulator 216, respectively, for communication purposes and are configured to sense a pressure P relating to the brake system 250′ and to transmit it to the control unit 220

The vehicle 200a, 200b has a parking brake switch 235 for actuating the parking brake system 250 and for controlling the parking brake function 251. The parking brake switch 235 can, for example, be configured as a parking brake actuator button or a parking brake rocker switch.

The parking brake switch 235 is a user interface at which a user and/or driver of the vehicle 200a, 200b can make a user input 254 to operate the parking brake system 250. The parking brake switch 235 and the control unit 220 or the rear axle modulator 216 are each connected to the parking brake module 217 for communication purposes in order to transmit the user input 254 to the parking brake module 217.

The vehicle 200a, 200b includes two compressed air reservoirs 210. The compressed air reservoirs 210 are each configured to provide compressed air for operating the parking brake system 250 and the service brake system 250a. For this purpose, the compressed air reservoirs 210 are each configured to compress air and/or store compressed air. The compressed air reservoirs 210 are pneumatically connected to actuators 205 via the front axle modulator 215, the rear axle modulator 216 and/or the parking brake module 217.

The vehicle 200a, 200b or the parking brake system 250 and the service brake system 250a has a plurality of actuators 205. Each of the actuators 205 can be supplied with air from the compressed air supply 210 and can thus be ventilated to achieve a braking effect.

The electropneumatic brake system 250′ includes a controllable vent valve arrangement 130, in particular one vent valve arrangement 130 per wheel brake. The vent valve arrangement 130 is configured to vent, that is, release air from, a working volume (not indicated) of each of the actuators 205 and thus the parking brake system 250 or the service brake system 250a.

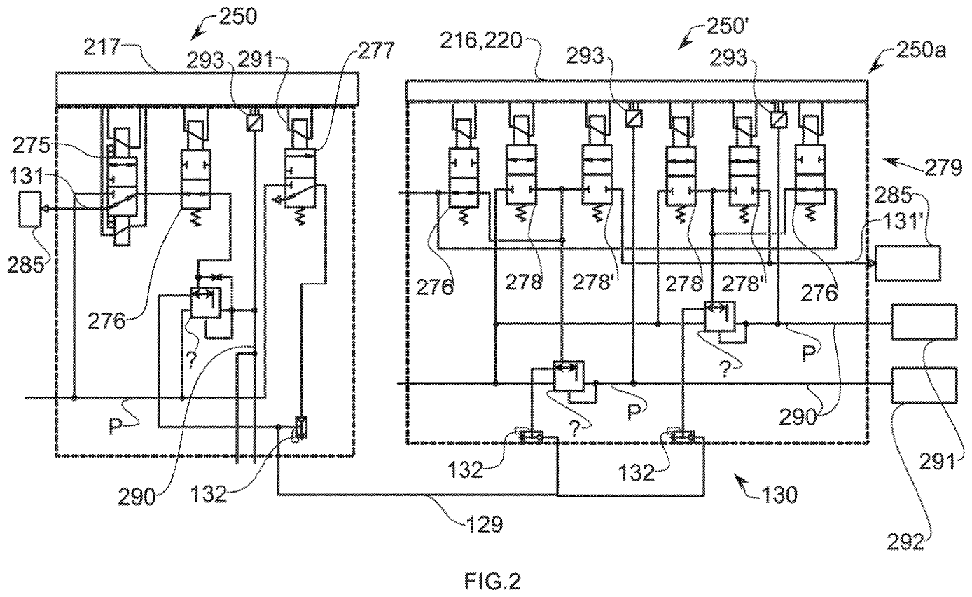

The electropneumatic brake system 250′ has one ABS valve 206 per actuator 205 as a rapid-venting valve. Each of the ABS valves 206 is connected to an actuator 205, Each of the actuators 205 is configured to brake a wheel 201 or a pair of wheels 201 of the vehicle 200a, 200b. The vehicle 200a, 200b includes two silencer devices 285 (see schematic FIG. 2), and the ABS valves 206 are configured to vent via the silencer devices 285.

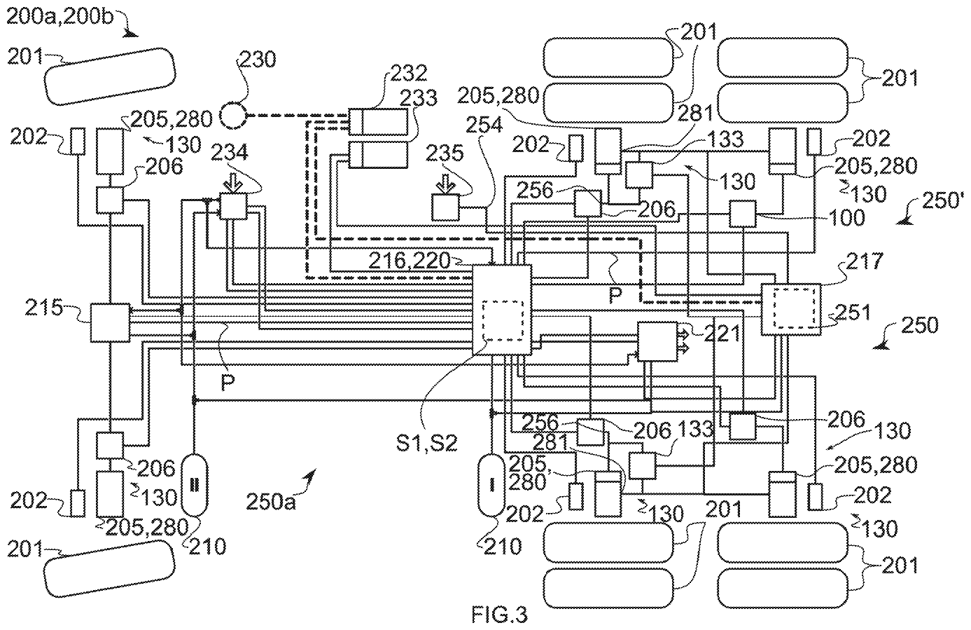

The electropneumatic brake system 250′ has a venting path 129 (see FIGS. 2 and 3) for pneumatically connecting the parking brake system 250 to the service brake system 250a. The vent valve arrangement 130 is configured to control venting of the parking brake system 250 via the venting path 129 and via the service brake system 250a. Compressed air can be transferred from the parking brake system 250 to the service brake system 250a via the venting path 129 in order to be discharged through the service brake system 250a. Here, the vent valve arrangement 130 is configured to vent the parking brake system 250 in two steps S1, S2. The vent valve arrangement 130 is thus configured to control the venting of the parking brake system 250 in a first step S1 via the service brake system 250a and in a second step S2 via a discharge path 131 of the parking brake system 250 that is different from the venting path 129, The venting according to the two steps S1, S2 is described in more detail with reference to FIG. 2.

The vehicle 200a, 200b each has wheel speed sensors 202 connected to the control unit 220 for communication purposes. The wheel speed sensors 202 are each configured to detect the speed or rotational speed of one or more of the wheels 201 and to transmit this information to the control unit 220. The control unit 220 can process the detected speeds or rotational speeds and use them to initiate an automated driving function 230.

The vehicle 200a, 200b has a vehicle bus 232, for example a CAN bus, which is configured to connect components of the vehicle 200a, 200b for communication purposes. For example, information relating to an automated driving function 230 can be transmitted via the vehicle bus 232 from or to the control unit 220 and/or the rear axle modulator 216, as illustrated schematically with a dashed line.

The vehicle 200a, 200b has a power supply 233 for providing electrical energy to the electropneumatic parking brake system 250 and the electropneumatic service brake system 250a. The power supply 233 is, for example, an electrochemical energy storage device and is electronically connected to the control unit 220. The control unit 220 can supply electrical energy to components of the parking brake system 250 and the service brake system 250a.

The vehicle 200a, 200b has a trailer vehicle control module 221. The trailer vehicle control module 221 is configured to connect the vehicle 200a, 200b to a trailer vehicle (not shown) for communication purposes. The trailer vehicle control module 221 is connected to the control unit 220 for communication purposes. The control unit 220 can transmit information relating to the braking of the vehicle 200a, 200b to the trailer vehicle control module 221 or, via the trailer vehicle control module 221, to the trailer vehicle, for example a brake request and/or a signal for controlling the lighting system of the trailer vehicle.

FIG. 2 shows a schematic illustration of an electropneumatic brake system 250′ according to an aspect of the disclosure. The electropneumatic brake system 250 according to FIG. 2 is an electropneumatic brake system 250′ for a vehicle 200a, in particular commercial vehicle 200b. Such a vehicle 200a, 200b and such an electropneumatic brake system 250 are described with reference to FIG. 1. FIG. 2 is described with reference to FIG. 1.

FIG. 2 shows a possible embodiment of the electropneumatic brake system 250′, in which a pneumatic connection between the service brake system 250a and the parking brake system 250 is provided via a venting path 129 configured as a bypass. The parking brake system 250 is vented via a vent valve arrangement 130 and, in particular, via the rear axle modulator 216 and interposed quick release valves 132.

The parking brake system 250 has a 3/2-way valve 275, a 2/2-way valve 276, a second 3/2-way valve 277, and the parking brake module 217, each of which can be controlled electronically by the parking brake module 217. The parking brake module 217 has a signal interface 293 for receiving an actuation signal 290 for activating the parking brake function 251 and for detecting a pressure P relating to the parking brake system 250. The actuation signal 290 may be, for example, a signal from the parking brake switch 235 (see FIG. 1).

The second 3/2-way valve 277 is pneumatically connected to the 2/2-way valve 276 of the parking brake system 250 via a relay valve 252 of the parking brake system 250, wherein the 2/2-way valve 276 is configured as a normally open 2/2-way valve 276.

The 2/2-way valve 276 is also pneumatically connected to the 3/2-way valve 275, via which the venting of the parking brake system 250 can be controlled. The 3/2-way valve 275 is enclosed by the vent valve arrangement 130. The 3/2-way valve 275 can be controlled via the parking brake module 217 and has an outlet path 131 that opens into a silencer device 285.

The 3/2-way valve 275 is configured to selectively discharge compressed air via the discharge path 131 into the silencer device 285 or to transfer compressed air via the vent path 129 into the service brake system 250a or to vent it into the service brake. The mode switch between venting into the service brake system 250a and venting into the environment via the discharge path 131 is performed by the 3/2-way valve 275 in the parking brake system 250.

The service brake system 250′ has the rear axle modulator 216 configured as a control unit 220. The rear axle modulator 216 has two signal interfaces 293 via which the rear axle modulator 216 can be redundantly supplied with an actuation signal 290 via a first signal path 291 and a second signal path 292 and via which a pressure P relating to the service brake system 250a can be detected. The actuation signal 290 may be, for example, a signal from the brake transducer 234 (see FIG. 1).

In accordance with the redundant configuration of the signal paths 291, 292, the service brake system 250a has a redundantly configured valve arrangement 279. The valve arrangement 279 includes two normally open 2/2-way valves 276, one normally closed second 2/2-way valve 278, and one normally closed third 2/2-way valve 278′. The respective normally open 2/2-way valve 276 can be pressurized with air and is pneumatically connected to the second 2/2-way valve 278 and the third 2/2-way valve 278′. The respective third 2/2-way valve 278′ is configured to vent the service brake system 250a via a silencer device 285.

The parking brake system 250 includes two quick-release valves 132 as parts of the vent valve arrangement 130, and the service brake system 250a can be pneumatically connected via the vent valve arrangement 130 and, in particular, the vent path 129. Compressed air can be transferred from the parking brake system 250 to the service brake system 250a via the vent valve arrangement 130 and vented via the service brake system 250a.

Here, the vent valve arrangement 130 is configured to vent the parking brake system 250 in two steps S1, S2. The vent valve arrangement 130 is thus configured to control the venting of the parking brake system 250 in a first step S1 via the service brake system 250a and in a second step S2 via a discharge path 131 of the parking brake system 250 that is different from the venting path 129. For this purpose, in the first step S1, the 3/2-way valve 275 of the parking brake system 250 can be controlled in such a way that compressed air at a pressure P is transferred to the service brake system 250a via the vent path 129. In the second step S2, after the pressure P in the parking brake system 250 has dropped, the 3/2-way valve 275 of the parking brake system 250 can be controlled in such a way that compressed air is discharged into the environment via the discharge path 131 and the silencer device 285. In addition, the service brake system 250a can be controlled in such a way that the air transferred from the parking brake system 250 to the service brake system 250a is discharged via the second discharge path 131′ and the silencer device 285.

FIG. 3 shows a schematic illustration of a vehicle 200a, in particular a utility vehicle 200b, according to an aspect of the disclosure. FIG. 3 is an alternative embodiment of the vehicle 200a, 200b according to FIG. 1. FIG. 3 is described with reference to FIGS. 1 and 2, describing the differences between the embodiments according to FIGS. 1 and 2 and FIG. 3.

FIG. 3 shows a vehicle 200a, 200b in which the vehicle 200a, 200b has two solenoid valves 133 (SV) included of the vent valve arrangement 130. The solenoid valves 133 are connected to the parking brake module 217 for communication purposes so that they can be supplied with a signal from the parking brake module 217 to control the solenoid valves 133.

The parking brake system 250 has a spring accumulator 280 with a vent port 281 for each actuator 205, and the service brake system 250a has a service brake connection 256 on the ABS valves 206. The solenoid valves 133 are pneumatically connected between the vent port 281 and the service brake port 256.

The solenoid valves 133 are configured to establish a connection between the vent port 281 and the service brake port 256 for the first step S1 of venting the parking brake system 250. Compressed air can then be transferred from the spring accumulators 280 of the parking brake system 250 to the service brake system 250a. Further venting can be performed as described with reference to FIGS. 1 and 2.

FIG. 4 shows a schematic illustration of flow chart of a method 300 according to an aspect of the disclosure. The method 300 according to FIG. 4 is a method 300 for operating an electropneumatic brake system 250′, A brake system of this kind is described with reference to FIGS. 1 to 3. FIG. 4 is described with reference to FIGS. 1 to 3.

The method 300 according to FIG. 4 includes: detecting 310 an actuation signal 290 for actuating the parking brake system 250.

The method 300 includes: determining 320 a control signal 291 for controlling the vent valve arrangement 130 based on the actuation signal 290.

The method 300 includes: outputting 330 the control signal 291.

FIG. 5 shows a schematic illustration of a computer-readable medium 400 according to an aspect of the disclosure. The computer-readable medium 400 includes commands (not shown) which, when the program or the commands is or are executed by a control unit 220, cause the latter to carry out the method 300 and/or the steps of the method 300 according to FIG. 4.

The commands may be present as a program code in any code or language, in particular in a code that is suitable for motor vehicle controllers. The computer-readable medium 400 may be or include any digital data storage device, such as a USB stick, a hard disk, a CD-ROM, an SD card, or an SSD card. The computer program does not necessarily have to be stored on such a computer-readable storage medium, but may also be retrievable via the Internet or in some other way

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

130 Vent valve arrangement
131 Discharge path
131′ Second discharge path
132 Quick release valve
133 Solenoid valve
201 Wheel
202 Wheel speed sensor
205 Actuator
206 ABS valve
210 Compressed air reservoir
215 Front axle modulator
216 Rear axle modulator
217 Parking brake module
220 Control unit
221 Trailer vehicle control module
222 Valve control module
230 Automated driving function
232 Vehicle bus
233 Energy supply
234 Brake transducer
235 Parking brake switch
250′ Electropneumatic brake system
250 Electropneumatic parking brake system
250a Electropneumatic service brake system
251 Parking brake function
253 Parameter
254 User input
255 Binary request signal
256 Service brake port
260 Compressed air inlet
265 Main port
270 Hold valve
275 3/2-way valve
276 2/2-way valve, NO (normally open)
277 Second 3/2-way valve
278 Second 2/2-way valve, NC (normally closed)
278′ Second 2/2-way valve, NC (normally closed)
279 Valve arrangement
280 Spring accumulator
281 Vent port
285 Silencer device
290 Actuation signal
291 Control signal
292 First signal path
292 Second signal path
293 Signal interface
300 Method
310 Detection
320 Determination
330 Output
400 Computer-readable medium
S1 First step
S2 Second step
P Pressure

1. An electropneumatic brake system for a vehicle, the electropneumatic brake system comprising:
a parking brake system;
a service brake system;
a controllable vent valve arrangement;
a venting path for pneumatically connecting said parking brake system to said service brake system; and,
said vent valve arrangement being configured to control venting of said parking brake system via said venting path and via said service brake system.

2. The electropneumatic brake system of claim 1, wherein said vent valve arrangement is configured to perform venting of said parking brake system in two steps.

3. The electropneumatic brake system of claim 2, wherein said vent valve arrangement is configured to control the venting of said parking brake system in a first step of said two steps via said service brake system and in a second step of said two steps via a discharge path of said parking brake system that is different from said venting path.

4. The electropneumatic brake system of claim 1, wherein said vent valve arrangement has a quick-release valve.

5. The electropneumatic brake system of claim 1, wherein said vent valve arrangement has a 3/2-way valve controllable by said parking brake system.

6. The electropneumatic brake system of claim 1, wherein:
said parking brake system includes a spring accumulator and a vent port;
said service brake system has a service brake port; and,
said vent valve arrangement includes a solenoid valve connected between said vent port and said service brake port.

7. The electropneumatic brake system of claim 1, wherein:
said electropneumatic brake system includes a silencer device; and,
at least one of said parking brake system and said service brake system are configured to vent via said silencer device.

8. The pneumatic brake system of claim 1, wherein the vehicle is a commercial vehicle.

9. A method for operating an electropneumatic brake system of a vehicle, the electropneumatic brake system including a parking brake system, a service brake system, a controllable vent valve arrangement, and a venting path for pneumatically connecting the parking brake system to the service brake system; the vent valve arrangement being configured to control venting of the parking brake system via the venting path and via the service brake system, the method comprising:
detecting an actuation signal for actuating the parking brake system;
determining a control signal for controlling the vent valve arrangement based on the actuation signal; and,
outputting the control signal.

10. A computer program comprising commands stored on a non-transitory computer readable medium which, when the program is executed by a control unit, cause the control unit to carry out the method of claim 9.

11. A computer-readable medium comprising commands which, when the commands are executed by a control unit, cause the control unit to carry out the method of claim 9.

12. A control unit for an electropneumatic brake system, the electropneumatic brake system including a parking brake system, a service brake system, a controllable vent valve arrangement, and a venting path for pneumatically connecting the parking brake system to the service brake system; the vent valve arrangement being configured to control venting of the parking brake system via the venting path and via the service brake system, the control unit comprising:
a processor;
a non-transitory computer readable medium having program code stored thereon;
said program code being configured, when executed by said processor, to:
detect an actuation signal for actuating the parking brake system;
determine a control signal for controlling the vent valve arrangement based on the actuation signal; and,
output the control signal.

13. A vehicle comprising the control unit of claim 12.

14. The vehicle of claim 13, wherein the vehicle is a commercial vehicle.

15. A vehicle comprising the electropneumatic brake system of claim 1.

16. The vehicle of claim 15, wherein the vehicle is a commercial vehicle.
